(19) United States
(12) Patent Application Publication
(10) Pub. No.: US 2007/0225989 A1
(43) Pub. Date: Sep. 27, 2007

(54) System and method for managing enterprise environmental impacts

(76) Inventors: George Whitley, Austin, TX (US); Juan Garza, Austin, TX (US); Oludolapo Osoba, Hutto, TX (US); Lucian Turk, Pflugerville, TX (US)

Correspondence Address: HAMILTON & TERRILE, LLP, P.O. BOX 203518, AUSTIN, TX, 78720, US

(21) Appl. No.: 11/385,518

(22) Filed: Mar. 21, 2006

(51) Int. Cl. G06Q 10/00; G06Q 30/00

(52) U.S. Cl. 705/1

(57) ABSTRACT

Environmental impacts from enterprise operations are efficiently and accurately tracked and reported. Manufacturing resource activities and sales and recovery activities are automatically aggregated for selection of environmental information by an environmental impact engine and storage at an environmental impact database. The environmental information is coordinated for presentation as environmental impact reports that are verified with an audit module by reference to the environmental impact database. Accurate and verifiable environmental impact information enables planning of manufacture processes that efficiently use environmental resources and tracking of manufacturing to verify that manufacturing processes manage resources in a socially responsible manner.

### BACKGROUND OF THE INVENTION

1. Field of the Invention

The present invention relates in general to the field of managing enterprise environmental impacts, and more particularly to a system and method for managing environmental impacts relating to design, production, and recovery of information handling systems and peripherals.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have touched and improved virtually every aspect of modem society. Indeed, every day information handling systems help to save lives, such as, for instance, through direct analysis of medical factors to aid doctors, through management of auto or air traffic to safely transport people or by helping scientists to better understand the complex problems that challenge society. Naturally, as public and private enterprises have come to depend on information handling systems they have also sought reliable, effective and cost efficient solutions. Dell Corporation has responded with a build-to-order manufacturing process that enables enterprises to manage information handling system purchases in a direct manner. By giving enterprises greater control over the systems they select, enterprise resources are applied in an efficient and cost effective manner. For example, the research scientist specifies a system built with advanced math processing capability and large storage capacity while the network-based assistant has a basic system to handle word processing or other administrative functions. The build-to-order model not only satisfies end users who get the system they want and need, but it also helps with the efficient allocation of resources. Since end users select components that are included in a built-to-order system, unnecessary components are avoided so that disposal of the system at the end of its life presents less of an impact on the environment.

Although the build-to-order system inherently reduces the environmental impact of disposal at system end-of-life, other considerations exist for managing the environmental impact of information handling system design, production and recovery. For instance, during production of information handling systems environmental impacts occur that relate manufacturer facilities energy usage, non-hazardous waste metrics, product recovery volumes to recycling, reuse and disposition, and logistics fuel and mileage information. Accurate tracking of such information is difficult for a number of reasons. For instance, build-to-order efficiencies improve the delivery of the right product to the right end user but involve great complexity in the variations of systems built, the transporting and arranging of components for assembly and the variety of suppliers of components. Often, metrics that are useful for tracking environmental impacts are manually gathered and tracked, leaving room for inadvertent errors and inconsistent data formats used by various suppliers and manufacturing units. For example, energy use, waste recycling and disposal and product recovery operations are typically tracked with manual invoices by different functional groups. High volumes of data have made the organization and practical use of this information a struggle. Growing concerns about the environmental impact of information handling system disposal are difficult to address absent a coordinated review of the wide variety of environmental information relating not only to information handling system disposal but also design, production, use and recovery.

### SUMMARY OF THE INVENTION

Therefore a need has arisen for a system and method which manages enterprise environmental impacts, such as for the manufacture of information handling systems.

In accordance with the present invention, a system and method are provided which substantially reduce the disadvantages and problems associated with previous methods and systems for managing enterprise environmental impacts. Manufacturing information and sales and recovery information are aggregated for selection of environmental information stored in an environmental impact database and accessible to report on the environmental impact of production.

More specifically, a manufacturing resource module aggregates manufacturing information associated with one or more products, and a sales and recovery module aggregates sales and recovery information associated with the products. An environmental impact engine interfaced with the manufacturing resource module and the sales and recovery module selects environmental impact information under the management of an administrative module and stores the environmental impact information in an environmental impact database. An environmental impact report module interfaces with the environmental impact database to generate reports for the environmental impact of the one or more products. Comprehensive audits of environmental impacts are provided by an environmental impact audit module that verifies environmental impact reports by reference to the environmental impact database.

The present invention provides a number of important technical advantages. One example of an important technical advantage is that environmental affairs monitoring is supported from enterprise to employee levels to better manage enterprise environmental impacts. Environmental reporting accuracy is improved with direct tracking of inputs from suppliers and throughout varying business units. Comprehensive and accurate sustainability and environmental reports are responsive to enterprise employees to run queries, produce metrics, pull compliance reports and provide verification support for enterprise environmental impacts, such as in response to environmental audits. For instance, metrics might include use of water and energy, such as gas and electric, or even energy sources, such as renewable versus non-renewable. Ready access to a dedicated environmental impact database allows rapid and user friendly report generation, such as timeline-base and trend reporting formats and graphs. Greater volumes of information are tracked automatically and with less risk of inadvertent errors so that an enterprise may better act in an environmentally sensitive manner and better support environmentally based decisions with appropriate due diligence and socially responsible investment choices.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for managing enterprise environmental impacts associated with manufacture of one or more products;

FIG. 2 depicts a flow diagram of a process for aggregating manufacturing information to select and report environmental information;

FIG. 3 depicts a flow diagram of a process for aggregating sales and recovery information to select and report environmental information;

FIG. 4 depicts a flow diagram of a process for administration of the aggregating and selecting of environmental information; and

FIG. 5 depicts an environmental impact database schema.

### DETAILED DESCRIPTION

Automatically tracking manufacturing, sales and recovery of products, such as information handling systems, provides accurate and timely environmental impacts associated with the products. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

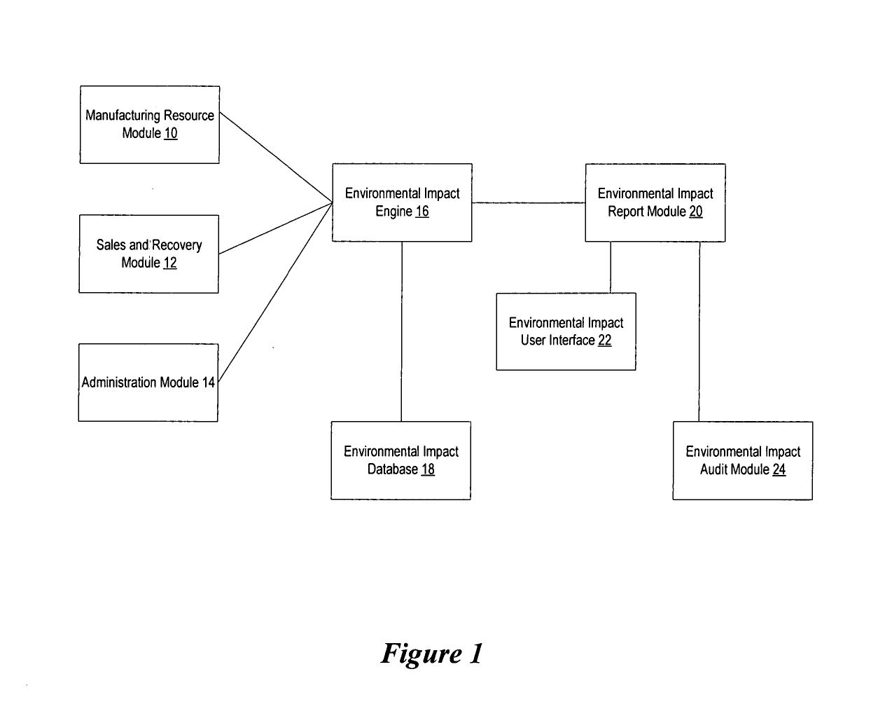

Referring now to FIG. 1, a block diagram depicts a system for managing enterprise environmental impacts associated with manufacture of one or more products. A manufacturing resource module 10 aggregates manufacturing information associated with manufacture of one or more products, such as information handling systems and related peripherals. A sales and recovery module 12 aggregates sales and recovery information for the one or more products, such as resources applied to accomplish sales and the recovery, reuse and/or disposal of sold products. An administration module 14 manages the information that is aggregated and the treatment of the information after it is aggregated. An environmental impact engine 16 interfaces with manufacturing resource module 10, sales and recovery module 12 and administration module 14 to selected environmental information from the aggregated manufacturing, sales and recovery information. Environmental impact engine 16 stores the environmental information in an environmental impact database 18. An environmental impact report module 20 interfaces with environmental impact engine 16 to access environmental impact database 18 for preparing environmental impact reports related to the product or products. For instance, predetermined reports are run at regular intervals or in response to queries from an environmental impact user interface 22. Environmental impact reports are audited by an environmental impact audit module 24 which retrieves supporting information from environmental impact database 18.

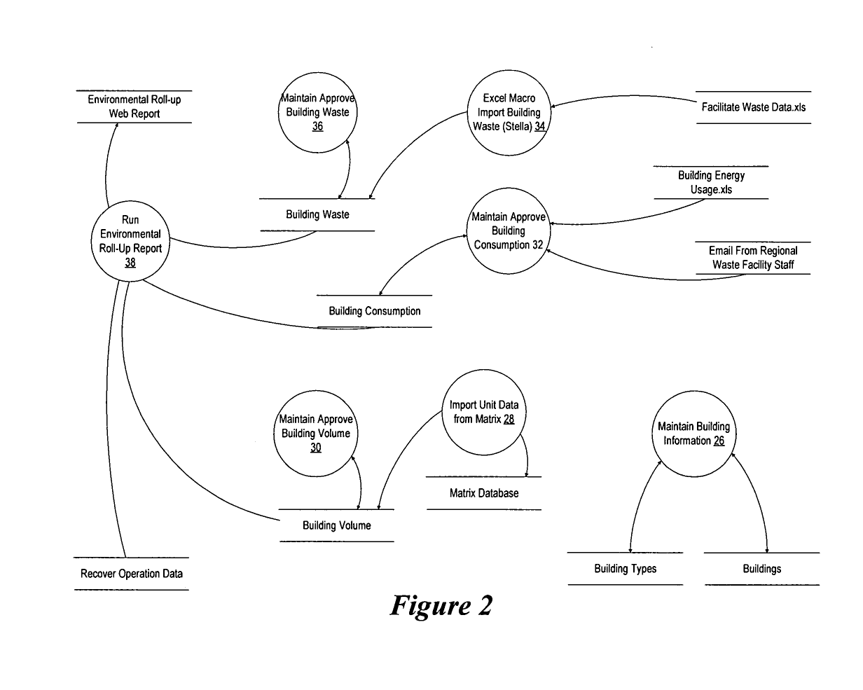

Referring now to FIG. 2, a flow diagram depicts a process for aggregating manufacturing information to select and report environmental information. In the course of normal operations, manufacturing information relating to building operations is kept at step 26 for each building and based on building type. At step 28, the building information is imported from a matrix database and, at step 30, integrated with building volume information. At step 32, manufacturing information is aggregated relating to building consumption, such as energy usage. At steps 34 and 36, manufacturing information is aggregated relating to building waste. The building volume, consumption and waste information is formatted to an environmental impact database format that supports selection of environmental information so that, at step 38, the environmental information is summarized in a roll-up report for presentation to an end user. The roll-up report presents environmental information in a predetermined manner that is customizable by user, region, product or particular units of measurement, such as kwh, water or units processed.

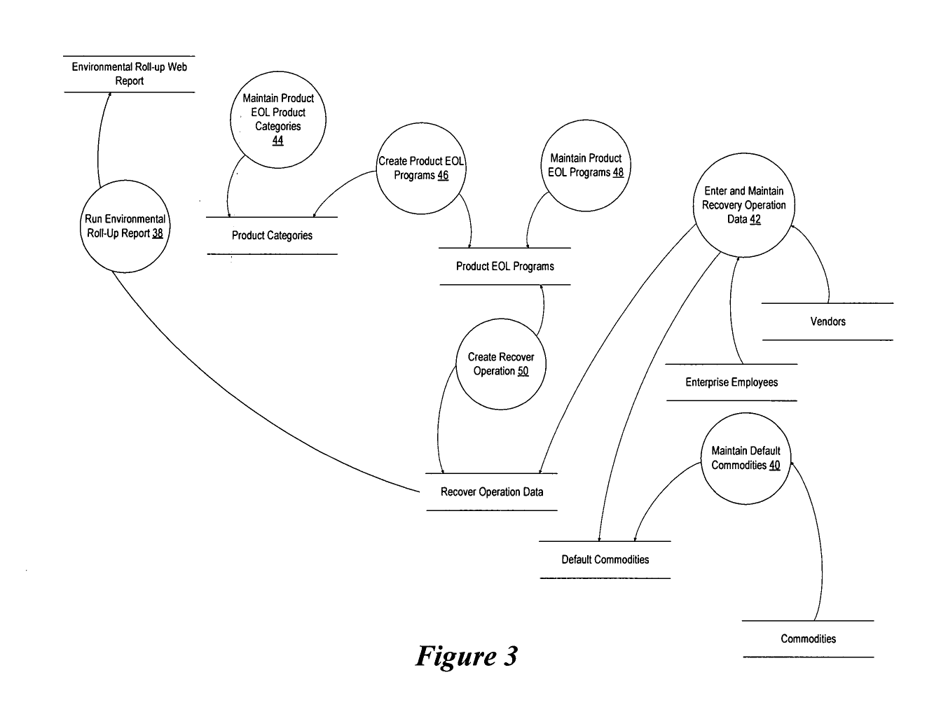

Referring now to FIG. 3, a flow diagram depicts a process for aggregating sales and recovery information to select and report environmental information. At step 40, predetermined default commodities are tracked for use in sales of products. At step 42, recovery operations information is maintained for the recovery of products by enterprise employees and outside vendors. At step 44, product end of life categories are defined and applied at step 46 to create product end of life programs. At step 48, the end of life programs are maintained by the entry of information relating to individual products. The product end of life information is applied at step 50 to create recovery operations for the recovery, recycling or other reuse of end-of-life products. The recovery operations information is then selected for use in the environmental roll-up report at step 38 to generate the environmental impact report. By aggregating information from each stage of the sales and recovery of each product, detailed resource use information is tracked, such as the fuel used to transport products, packaging materials used to ship products, and recycled commodities recovered from end of life products.

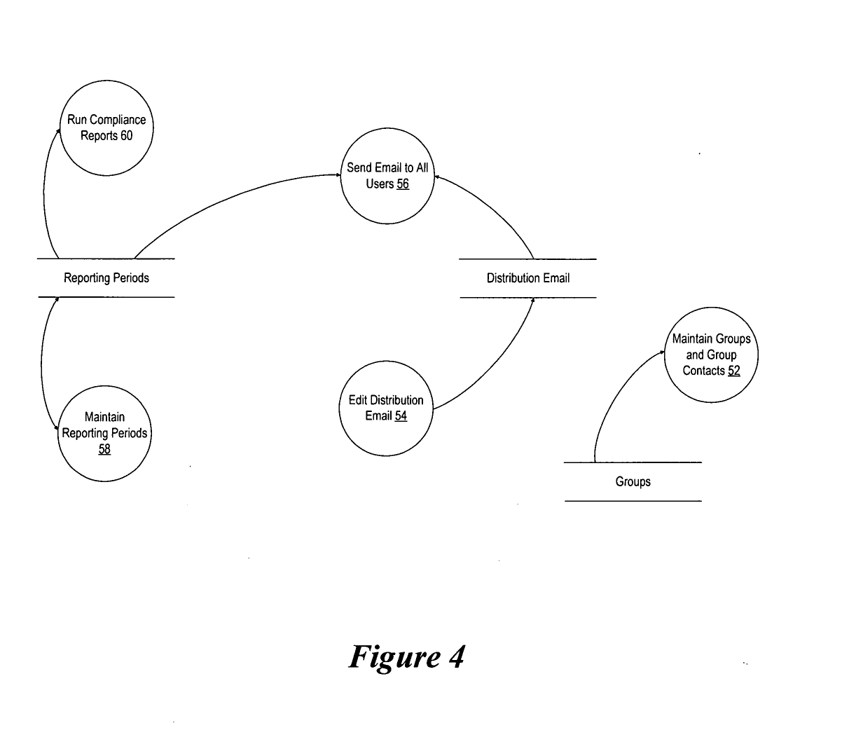

Referring now to FIG. 4, a flow diagram depicts a process for administration of the aggregating and selecting of environmental information. For instance, at step 52, desired groups and group contacts are maintained for supporting the collection of information and the distribution of reports. At step 54, a distribution e-mail list is maintained for distributing reminders to group contacts in support of the collection of information made at step 56. At step 58, separate reporting periods are maintained to track environmental impacts over time. At step 60, compliance reports are made to compare actual environmental impacts with predicted or desired impacts. The administration functions also might include the selection of types of data for inclusion in the environmental impact database, the types of data summarized for environmental reports and the management of access to the environmental impact database by enterprise employees.

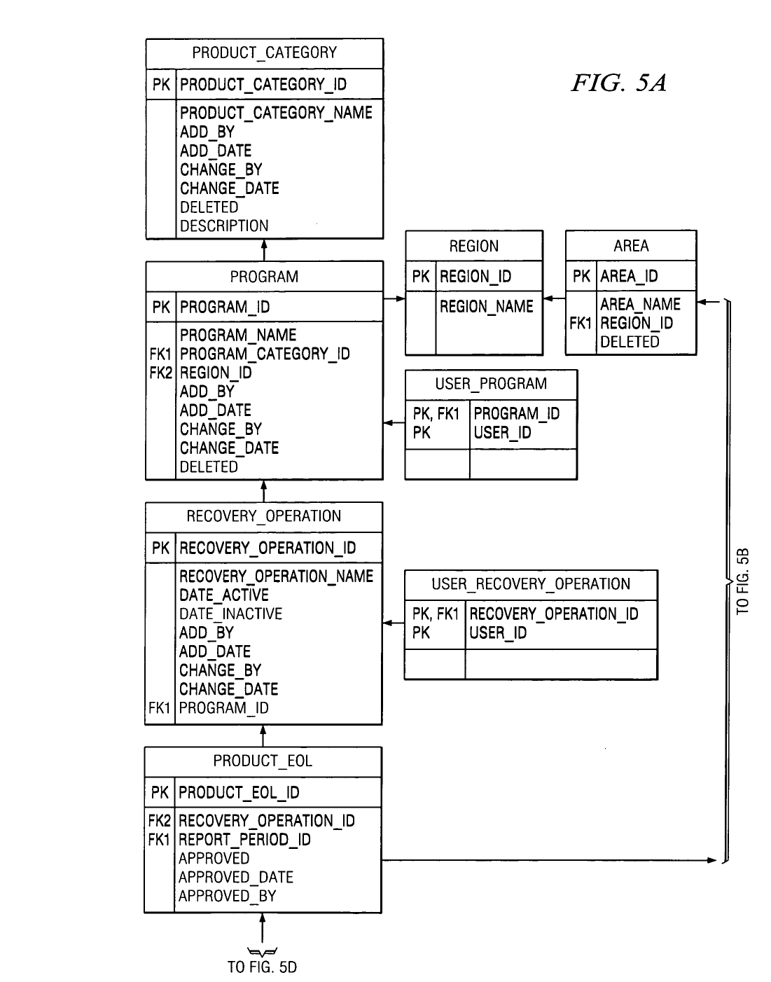

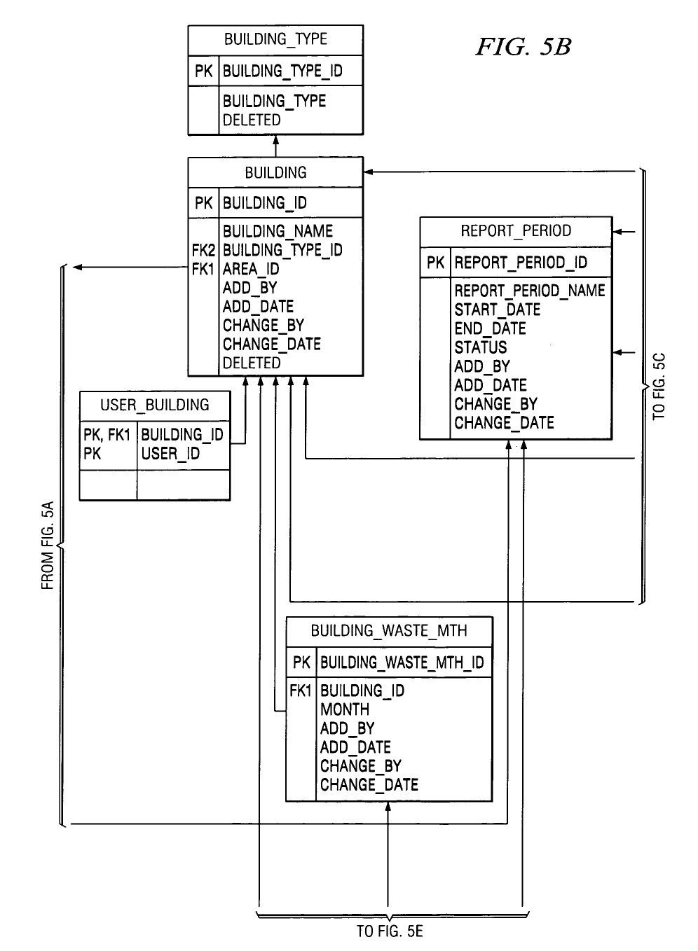

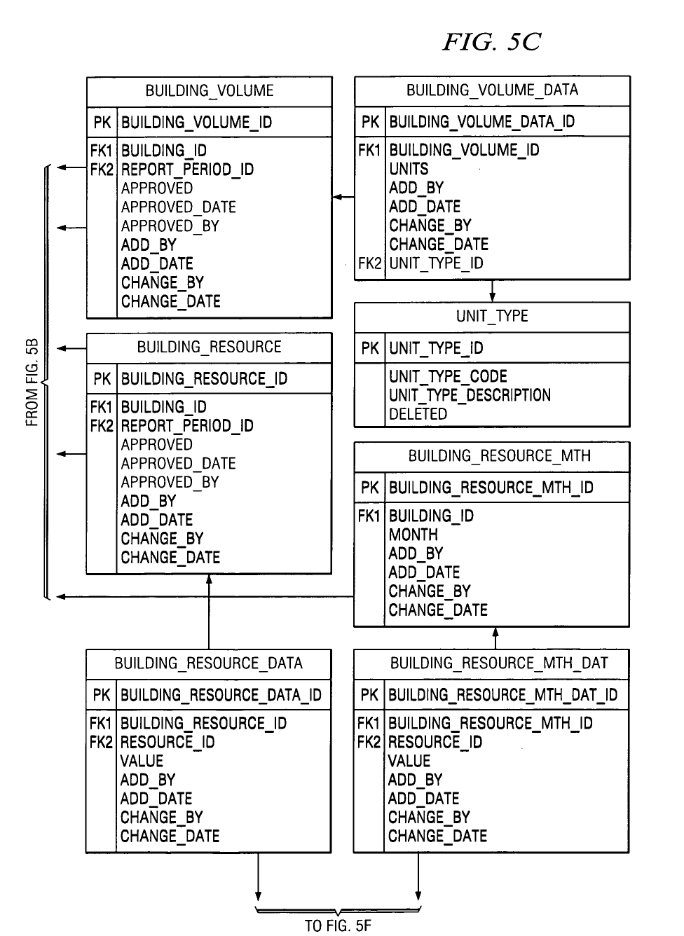

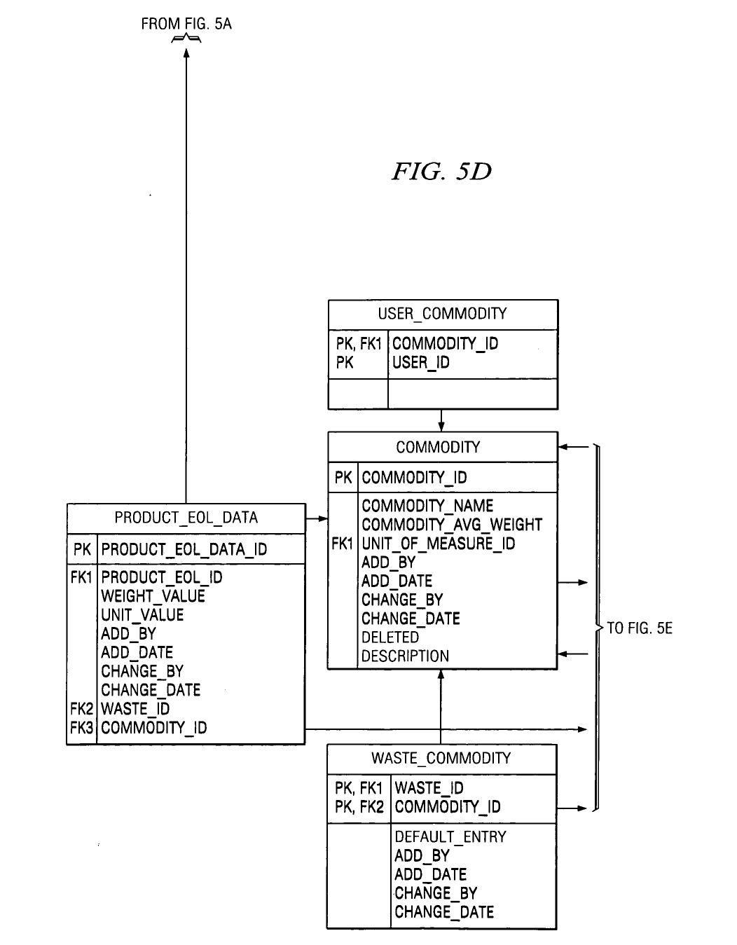

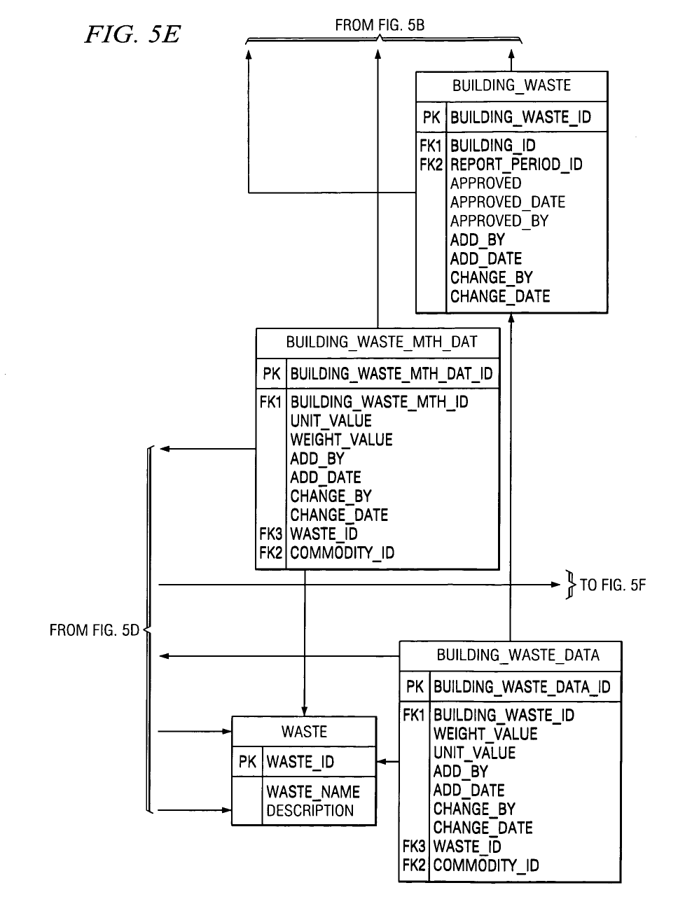

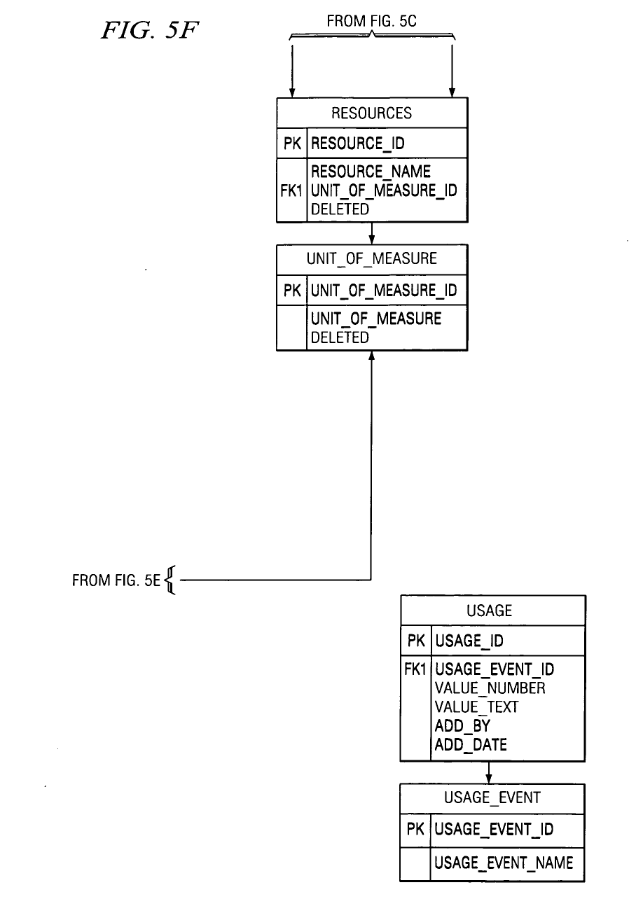

Referring now to FIG. 5, an environmental impact database schema depicts an example of storage of environmental information in an environmental impact database. Structured Query Language (SQL) provides for ready selection of desired information for inclusion in a report or compilation. Further, a Data Manipulation (DML) provides a definition of a database schema that fits within the normal usage model of the enterprise. For instance, building volume information that defines the building space associated with a product manufacture process is input at payment of building invoices, such as rent and power, so that desired information is imported to the environmental impact database. Similarly, commodity information associated with the sale of a product is input during the sales process as a part of normal operations, such as shipping and sales force fuel bills, so that desired information is imported to the environmental impact database. Integrating the environmental impact database with normal enterprise operations reduces the burden of tracking environmental information and helps to ensure employee and contractor compliance.

Although the present invention has been described in detail, it should be understood that various changes, substitutions and alterations can be made hereto without departing from the spirit and scope of the invention as defined by the appended claims.

What is claimed is:

1. A system for managing enterprise environmental reporting, the system comprising:
a manufacturing resource module operable to automatically aggregate manufacturing information associated with manufacture of one or more products;
a sales and recovery module operable to automatically aggregate sales and recovery information associated with sales and recovery of the products;
an environmental impact engine interfaced with the manufacturing resource module and the sales and recovery module, the environmental impact engine operable to automatically select environmental information from the manufacturing information and the sales and recovery information based on one or more predetermined factors; and
an environmental impact report module interfaced with the environmental impact engine and operable to report predetermined environmental information.

2. The system of claim 1 further comprising an environmental impact database interfaced with the environmental impact engine and operable to store the environmental information.

3. The system of claim 2 further comprising an environmental impact audit module interfaced with the environmental impact report module and operable to retrieve environmental information from the environmental impact database to verify environmental information of an environmental report.

4. The system of claim 1 further comprising an administration module interfaced with the environmental impact engine and operable to define the predetermined environmental information.

5. The system of claim 4 wherein the administration module is further operable to define the predetermined environmental information by geographic regions.

6. The system of claim 4 wherein the administration module is further operable to define the predetermined environmental information by product.

7. The system of claim 6 wherein the product comprises an information handling system.

8. The system of claim 1 wherein the manufacturing resource module aggregates manufacturing information at a building level.

9. The system of claim 8 wherein the manufacturing resource module is further operable to receive supplier invoices directed to a building.

10. The system of claim 1 wherein the sales and recovery module aggregates sales and recovery information at a product level.

11. A method for managing enterprise environmental reporting, the method comprising:
automatically aggregating manufacturing information associated with manufacture of one or more products;
automatically aggregating sales and recovery information associated with sales and recovery of the one or more products;
automatically selecting environmental information from the manufacturing information and the sales and recovery information based on one or more predetermined factors; and
reporting predetermined environmental information in a report in response to a report request.

12. The method of claim 11 further comprising:
automatically storing the environmental information in an environmental impact database.

13. The method of claim 12 further comprising:
receiving an audit request to audit a report; and
automatically retrieving environmental information from the environmental impact database in support of the report.

14. The method of claim 11 further comprising:
interfacing with the environmental impact engine to define the environmental information selected from the manufacturing information and the sales and recovery information.

15. The method of claim 14 wherein defining the environmental information further comprises defining environmental information by geographical region.

16. The method of claim 14 wherein defining the environmental information further comprises defining environmental information by product type.

17. The method of claim 16 wherein the product comprises an information handling system.

18. The method of claim 11 wherein automatically aggregating manufacturing informations further comprises aggregating manufacturing information by building location.

19. The method of claim 18 wherein automatically aggregating manufacturing information further comprises automatically aggregating supplier invoices.

20. The method of claim 11 wherein automatically aggregating sales and recovery information further comprises aggregating sales and recovery information by product type.
